(19) United States
(12) Patent Application Publication
(10) Pub. No.: US 2004/0136148 A1
(43) Pub. Date: Jul. 15, 2004

(54) Electronic device and case for thereof

(76) Inventor: Shen Chang Tsao, Taoyuan (TW)

Correspondence Address: BIRCH STEWART KOLASCH & BIRCH, PO BOX 747, FALLS CHURCH, VA, 22040-0747, US

(21) Appl. No.: 10/341,340

(22) Filed: Jan. 14, 2003

(51) Int. Cl. G06F 1/16

(52) U.S. Cl. 361/680; 361/724

(57) ABSTRACT

An electronic device includes a first case main body, a metallic bottom plate, and a second case main body. In this case, the first case main body has an opening and a plurality of flanges are formed inwardly on the edge of the opening. The metallic bottom plate combines with the first case main body so as to cover the opening. Therefore, the opening and the metallic bottom plate can form a containing space. The second case main body is cooperated with the first case main body to construct the body of the electronic device. Furthermore, this invention also discloses a case for the electronic device.

### BACKGROUND OF THE INVENTION

1. Field of Invention

The invention relates to an electronic device and a case for thereof and, in particular, to an electronic device and a case used in notebook computers and the likes.

2. Related Art

Recently, the competition of electronic devices begins like a raging fire, and the manufacturers have to provide better products or designs to increase their superiorities. Therefore, electronic devices could have good qualities and become more compact.

Generally speaking, the so-called electronic device could be a personal computer, a notebook computer, or a tablet PC. In the mentioned electronic devices, a case is necessary to protect a main circuit board or relative components.

For instance, a notebook computer, as shown in FIG. 1, includes an upper case 10 and a lower case 11 for assembling with the upper case 10. The upper case 10 and lower case 11 are used to protect the main circuit board and relative components of the notebook computer. The upper case 10 includes a case main body 100 having a keyboard containing space (not shown). A support plate 100a, which is integral with the case main body 100, is provided in the keyboard containing space and used to support a keyboard.

Furthermore, the support plate 100a may have a plurality of hollow portions 100b for mounting with metallic plates (not shown). Therefore, the metallic plates can prevent electromagnetic interfere (EMI). However, the support plate 100a may be not strong enough to support the keyboard and metallic plates while the total area of hollow portions 100b is too large. In addition, the conventional case main body 100 only partially provides with a metallic plate or metallic plates, so EMI cannot be entirely prevented.

In the mentioned notebook computer, since the support plate 100a is used to support a keyboard, it must have enough thickness so as to support the keyboard. Therefore, the notebook computer (or electronic device) has larger size. Moreover, since the metallic plate is partially provided, the preventive of EMI is only partially enhanced, so that the EMI cannot be totally eliminated efficiently.

Thus, it is an important subjective of the invention to provide an electronic device and a case which are more compact and good at preventing EMI.

### SUMMARY OF THE INVENTION

In view of the above-mentioned problems, an objective of the invention is to provide an electronic device, which is more compact and can prevent EMI efficiently, and a case for the electronic device.

The invention is characterized in providing a case main body having an opening for receiving a keyboard, wherein a plurality of flanges are formed inwardly on the edge of the opening. A metallic bottom plate is combined with one side of the case main body and used to cover the opening so that the opening and the metallic bottom plate can construct a containing space. In addition, the flanges and the metallic bottom plate can be used for supporting a keyboard.

To achieve the above-mentioned objective, the invention provides an electronic device including a first case main body, a metallic bottom plate, and a second case main body. In this invention, the first case main body has an opening and a plurality of flanges are formed inwardly on the edge of the opening. The metallic bottom plate is combined with the first case main body so as to cover the opening and to form a containing space. The second case main body is cooperated with the first case main body to construct the body of the electronic device.

Furthermore, the invention also discloses a case for an electronic device. The case of the invention includes a case main body and a metallic bottom plate. The case main body has an opening with a plurality of flanges around. The metallic bottom plate is combined with the case main body so as to cover the opening and to construct a containing space.

As mentioned above, since the electronic device (or case) of the invention has a plurality of flanges formed on the edge of the opening of the first case main body (or case main body), and a metallic bottom plate with good stiffness is provided at one side of the first case main body (or case main body), the electronic device can be thinner and more compact. Furthermore, the electronic device and case of the invention have a metallic bottom plate for covering the opening, so that EMI of the electronic device can be efficiently prevented. Briefly, the electronic device and case of the invention can not only achieve the objective of reducing EMI, but can also support a keyboard with a smaller thickness by utilizing the metallic bottom plate and the flanges.

### BRIEF DESCRIPTION OF THE DRAWINGS

The invention will become more fully understood from the detailed description given herein below illustration only, and thus are not limitative of the present invention, and wherein:

FIG. 1 is a schematic illustration showing partial of the conventional notebook computer;

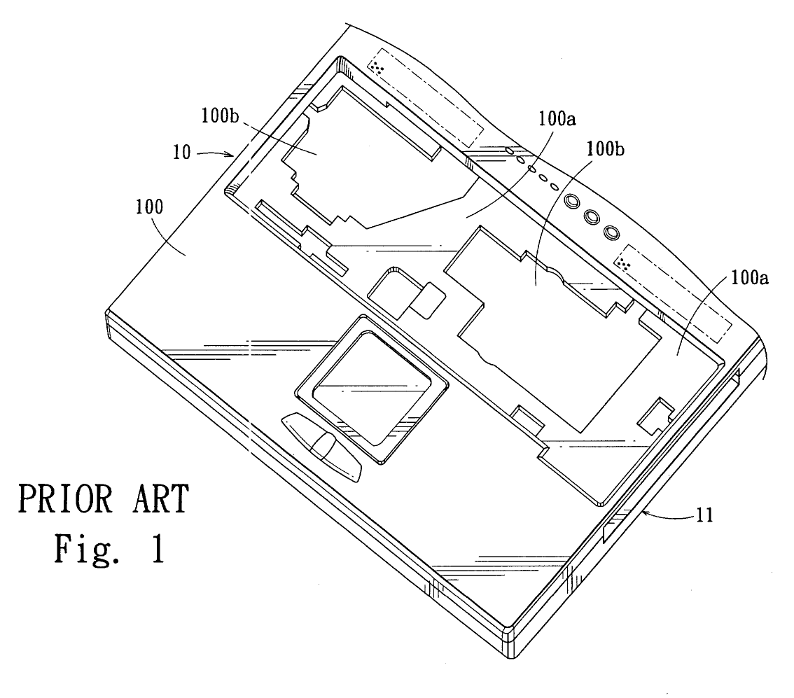

FIG. 2 is a schematic illustration showing an electronic device (notebook computer) according to a preferred embodiment of the invention; and

FIG. 3 is a schematic illustration showing a first case main body (or case main body) of the notebook computer according to a preferred embodiment of the invention.

### DETAILED DESCRIPTION OF THE INVENTION

The electronic device and case according to a preferred embodiment of the present invention will be described herein below with reference to the accompany drawings, wherein the same reference numbers refer to the same elements. It should be noticed that the current embodiment takes a notebook computer as an example to illustrate the electronic device of the invention.

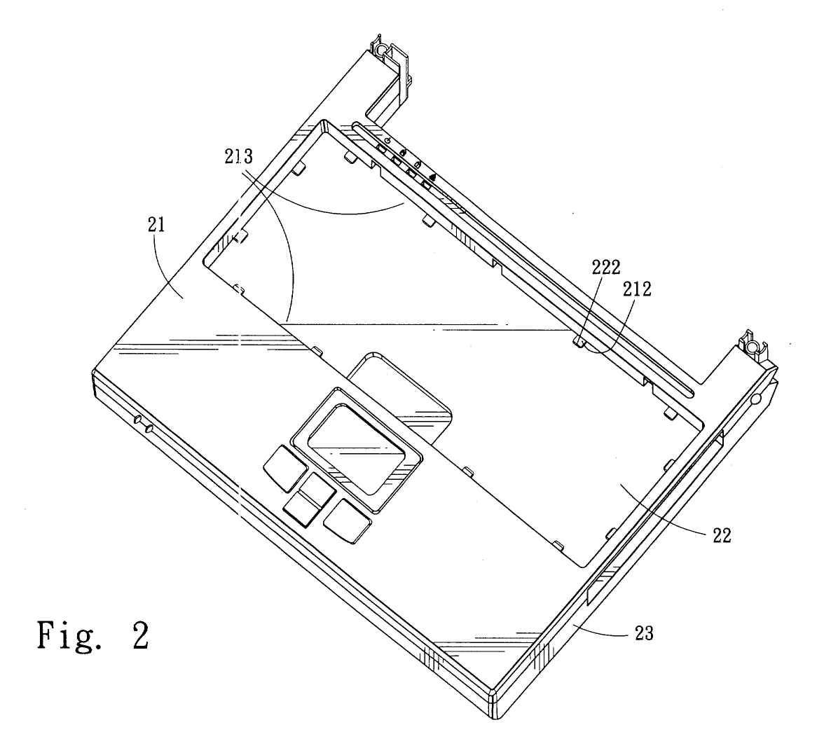

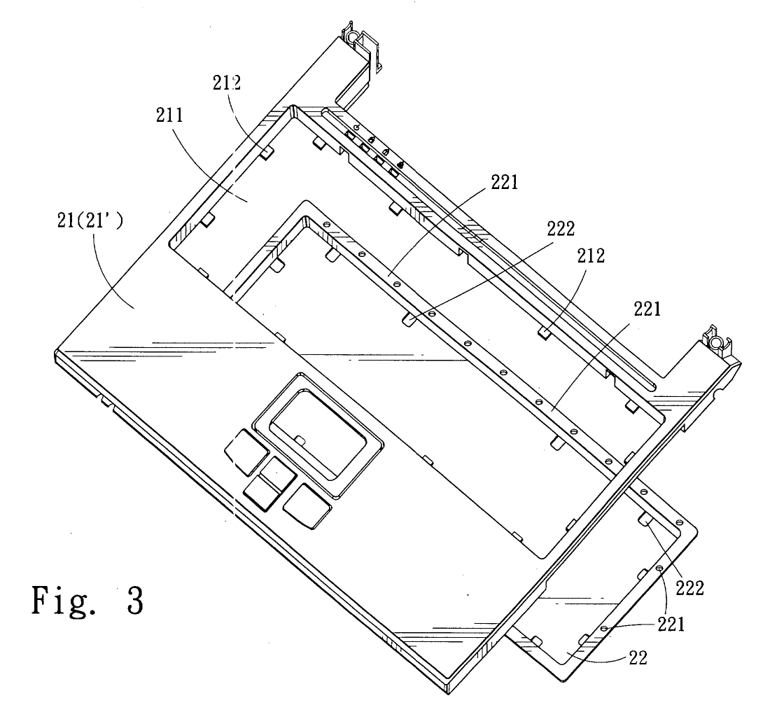

Referring to FIG. 2, an electronic device 2 of the invention includes a first case main body 21, a metallic bottom plate 22, and a second case main body 23. In this embodiment, the first case main body 21 has an opening 211 (as shown in FIG. 3). A plurality of flanges 212 are formed inwardly on the edge of the edge of the opening 211. The metallic bottom plate 22 is combined with the first case main body 21 to cover the opening 211 of the first case main body 21. Therefore, a containing space 213 is constructed of the opening 211 and metallic bottom plate 22. In this case, the metallic bottom plate 22 has a plurality of connecting holes 221, and the metallic bottom plate 22 is welded to the first case main body 21 through the connecting holes 221. The second case main body 23 is cooperated with the first case main body 21 to form the major body of the electronic device 2.

Please refer again to FIG. 3. The metallic bottom plate 22 further has a plurality of through holes 222 opposite to the flanges 212. When the metallic bottom plate 22 is combined with the first case main body 21, each of the through holes 222 can receive each of the flanges 212 perfectly. Moreover, the opening 211 and the metallic bottom plate 22 can form a containing space 213 for receiving a keyboard.

A case for an electronic device according to another preferred embodiment of the present invention will be described herein below with reference to FIG. 3, wherein the same reference numbers refer to the same elements illustrated above.

As shown in FIG. 3, a case for an electronic device includes a case main body 21′ and a metallic bottom plate 22. In this embodiment, the case main body 21′ has an opening 211, and a plurality of flanges 212 is formed inwardly on the edge of the opening 211. The metallic bottom plate 22 is placed at one side of the case main body 21′ and combined with the case main body 21′. Therefore, the metallic bottom plate 22 can cover the opening 211 of the case main body 21′ so as to form a containing space (not shown in FIG. 3). In the current embodiment, the metallic bottom plate 22 has a plurality of connecting holes 221, and the metallic bottom plate 22 is welded to the case main body 21′ through the connecting holes 221.

The metallic bottom plate 22 has a plurality of through holes 222 opposite to the flanges 212. When the metallic bottom plate 22 is combined with the case main body 21′, each of the through holes 222 can receive each of the flanges 212 perfectly. Therefore, the opening 211 and the metallic bottom plate 22 can form a containing space 213 capable of receiving a keyboard.

In summary, since the electronic device or case of the invention has a plurality of flanges formed inwardly on the edge of the opening of the first case main body (or case main body), and a metallic bottom plate with proper stiffness is provided at one side of the first case main body (or case main body), the electronic device can be thinner and more compact. Furthermore, the electronic device and case of the invention have a metallic bottom plate for covering the opening, so that the EMI issue of the electronic device can be efficiently prevented. Briefly, the electronic device and case of the invention can achieve the objective of reducing EMI, and they can further achieve the objective of supporting a keyboard with a thinner thickness by utilizing the stiff metallic bottom plate and the flanges on the edge of the opening.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A case for an electronic device, comprising:
a case main body having an opening, a plurality of flanges being formed on the edge of the opening; and
a metallic bottom plate for combining with the case main body so as to form a containing space.

2. The case of claim 1, which is a case of a notebook computer.

3. The case of claim 1, wherein the containing space is used for receiving a keyboard of the notebook computer, and the keyboard is supported with the flanges and the metallic bottom plate.

4. The case of claim 1, wherein the metallic bottom plate is combined with the case main body by utilizing welding method.

5. The case of claim 1, wherein the metallic bottom plate further has a plurality of through holes, and each of the through holes is located opposite to each of the flanges, so that each of the flanges is respectively received in the corresponding through hole.

6. An electronic device, comprising:
a first case main body having an opening, a plurality of flanges being formed on the edge of the opening;
a metallic bottom plate for combining with the first case main body so as to form a containing space; and
a second case main body, which is cooperated with the first case main body to construct the body of the electronic device.

7. The electronic device of claim 6, wherein the first case main body is a major body of a notebook computer.

8. The electronic device of claim 7, wherein the containing space is used for receiving a keyboard of the notebook computer, and the keyboard is supported with the flanges and the metallic bottom plate.

9. The electronic device of claim 6, wherein the second case main body is a major body of a notebook computer.

10. The electronic device of claim 9, wherein the containing space is used for receiving a keyboard of the notebook computer, and the keyboard is supported with the flanges and the metallic bottom plate.

11. The electronic device of claim 6, wherein the metallic bottom plate is combined with the case main body by utilizing welding method.

12. The electronic device of claim 6, wherein the metallic bottom plate further has a plurality of through holes, and each of the through holes is located opposite to each of the flanges, so that each of the flanges is respectively received in each corresponding through hole.
